(19) United States
(12) Patent Application Publication
(10) Pub. No.: US 2025/0174154 A1
(43) Pub. Date: May 29, 2025

(54) ENABLING DYNAMIC INFORMATION DISPLAY FOR VISUALLY IMPAIRED INDIVIDUALS THROUGH AN ARRAY OF WIRELESSLY CONFIGURABLE, EXPANDABLE, AND REUSABLE BRAILLE CELLS

(71) Applicant: KING FAISAL UNIVERSITY, AL-Ahsa (SA)

(72) Inventors: Matasem SALEH, Al-Ahsa (SA); Raazia SAHER, Al-Ahsa (SA); Qazi Mudassar ILYAS, Al-Ahsa (SA); Abid MEHMOOD, Al-Ahsa (SA)

(21) Appl. No.: 18/519,908

(22) Filed: Nov. 27, 2023

(51) Int. Cl. G09B 21/00; G06F 13/42

(52) U.S. Cl. CPC G09B 21/004; G06F 13/4247

(57) ABSTRACT

A novel system of powered dynamic reusable Braille cells (BCs) is designed for visually impaired individuals. Each BC, with six tactile dots, is wirelessly configurable and expandable, forming a network to present updated information efficiently. The system exploits a low-power wireless connectivity mechanism and physical connectivity mechanisms such as magnets or mechanical interlocks. The mechanisms facilitate communication with a host device enabling tactile dot configuration, reconfiguration, and resetting. The network allows a designated primary node for wireless communication, ensuring effective interaction with a controller. In addition to its core functionalities, the system enables a fault tolerance mechanism, where BCs with critically low battery levels trigger self-reset and notify adjacent BCs. A physical integrity mechanism continuously monitors the network, instantly detecting and responding to any physical loss or damage. Furthermore, a robust data integrity mechanism prevents the acceptance of invalid inputs, enhancing the reliability of information conveyed through the BC network.

### BACKGROUND

### 1. Field

The present disclosure relates to an expandable and configurable powered Braille cell system for efficiently conveying frequently updated information to individuals with visual impairments.

### 2. Description of the Related Art

Braille is a writing system that uses tactile dots on a surface to convey information, allowing individuals with visual impairments to read and write by touch. There are many uses for Braille in applications such as signs, labels, and price tags. This implementation enables individuals with visual impairments to engage autonomously with their immediate environment. In this context, it is often desirable to use Braille to convey information requiring frequent updates.

### SUMMARY

A practical design of an expandable and configurable powered Braille cell representing a single character is disclosed herein. Each Braille cell (BC) has a low-power wireless connectivity mechanism to receive instructions from the host device (e.g., a mobile device). The BC uses mechanisms such as ferrofluids, magnets, or actuators to show a character by raising the respective dots. To support information containing multiple characters, expansion is possible by connecting multiple BCs using connection mechanisms, such as mechanical interlocking or magnetic polarity. The cells, being magnetically connected, can easily be separated or joined. This allows a dynamic reconfiguration to communicate a different piece of information sent by the host. In this way, there is an innovative solution that provides a practical and dynamic approach for conveying frequently updated information through expandable and configurable powered BCs.

A dynamic reusable braille cell, in one embodiment, includes an outer shell having six tactile dots arranged in three rows and two columns. A raising and lowering mechanism is located proximal to the six tactile dots to raise and lower the six tactile dots. A control unit is in communication with the raising and lowering mechanism to raise and lower the tactile dots.

The dynamic reusable braille cell further includes a connection point allowing for two or more dynamic reusable braille cells to be connected to one another.

The connection point is located on a side of the outer shell and includes a magnet or a mechanical interlock. The connection point forms a network having a primary braille cell node and a secondary braille cell node.

The outer shell further includes a first indicator and a second indictor. The first indicator designates a primary braille cell and the second indicator designates a secondary braille cell.

A dynamic reusable braille cell system includes a plurality of dynamic reusable braille cell. Each of the plurality of dynamic reusable braille cells includes an outer shell having six tactile dots arranged in three rows and two columns. A raising and lowering mechanism is located proximal to the six tactile dots to raise and lower the six tactile dots. A control unit is in communication with the raising and lowering mechanism to raise and lower the tactile dots. Connection points are located on opposite sides of the outer shell and allow for connection of the plurality of dynamic reusable braille cells to one another to create a braille cell network.

These and other features of the present subject matter will become readily apparent upon further review of the following specifications.

### BRIEF DESCRIPTION OF THE DRAWINGS

FIG. 1 is an illustration of the overall dynamic reusable Braille cell (BC) system architecture.

FIG. 2 is an exploded perspective view of a dynamic reusable BC.

FIG. 3A is a bottom view of the dynamic reusable BC.

FIG. 3B is an external top view of the dynamic reusable BC.

FIG. 3C is an internal top view of the dynamic reusable BC.

FIG. 3D is an external front view of the dynamic reusable BC.

FIG. 3E is an internal front view of the dynamic reusable BC.

FIG. 3F is an internal side view of the dynamic reusable BC.

FIG. 3G is an external side view of the dynamic reusable BC.

FIG. 4A is an illustration of a magnetic connection mechanism.

FIG. 4B is an illustration of a mechanical interlocking connection mechanism.

FIG. 5A is an illustration of a single cell node network.

FIG. 5B is an illustration of a BC network comprising two nodes.

FIG. 5C is an illustration of an array of BCs to form a network having more than two nodes.

FIG. 6 is an illustration of a software component used to enable the functionality of a BC.

FIGS. 7A and 7B are illustration of the software component that allows discovery of and connection to available BC networks.

FIG. 8 is a graphical representation of the control device operation of querying the current configuration of the connected array of BCs.

FIG. 9 is a graphical representation of control device operation to reconfigure the connected array of BCs.

FIGS. 10A and 10B are illustrations of a control device resetting the current configuration of the BC network.

FIGS. 11A and 11B are illustrations showing how a fault tolerance mechanism operates.

FIGS. 12A and 12B are illustrations showing how a physical integrity mechanism operates.

FIGS. 13A and 13B are illustrations showing how data integrity is maintained.

Similar reference characters denote corresponding features consistently throughout the attached drawings.

### DETAILED DESCRIPTION OF THE PREFERRED EMBODIMENTS

It is often desirable to use Braille to convey information requiring frequent updates. Since frequent updates of Braille are difficult when using manual Braille mechanisms, solutions based on Braille pads (portable electronic devices featuring a series of tactile dots arranged in a Braille cell format) can be developed for dynamic updates. However, Braille pads may not be ideal for displaying frequently updated, small information pieces such as price tags because of several factors, including cost, size, portability, and durability. Braille cells as disclosed herein provide a practical solution through the design of an expandable and configurable powered Braille cell (BC) representing a single character. Each BC has a low-power wireless connectivity mechanism to receive instructions from the host device (e.g., a mobile device). The BC uses any of the existing mechanisms (e.g., ferrofluids, magnets, or actuators) to show a character by raising respective dots. To support information containing multiple characters, the BC allows for expansion by connecting multiple BCs together. The cells can easily be separated or joined, allowing a dynamic reconfiguration as required to communicate a different piece of information sent by the host. In this way, BCs are an innovative solution providing a practical and dynamic approach for conveying frequently updated information through expandable and configurable powered BCs.

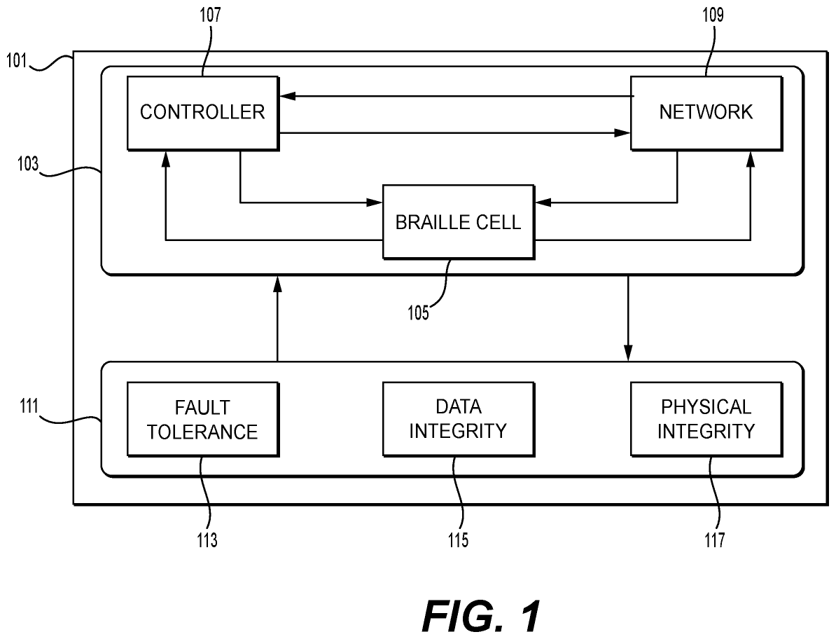

FIG. 1 shows the overall system architecture 101. The first subsystem 103 includes three components, i.e., Braille Cell 105, Controller or external controller 107, and Network 109. A BC network can contain one or more BCs physically connected to each other. A single-BC network can show only one character at a time. A network of multiple BCs is used to display a meaningful message. The BC network is connected to an external controller device that enables the network to perform its function. In the case of a multi-cell network, only one BC communicates with the external controller using a wireless connection. The second subsystem 111, also includes three components. Fault Tolerance component 113 ensures protection against possible faults in the network occurring because of battery failures in a BC. Data Integrity component 115 enables protection against inputs containing unsupported characters. Physical Integrity component 117 includes the system's response in case of possible physical damage to the network.

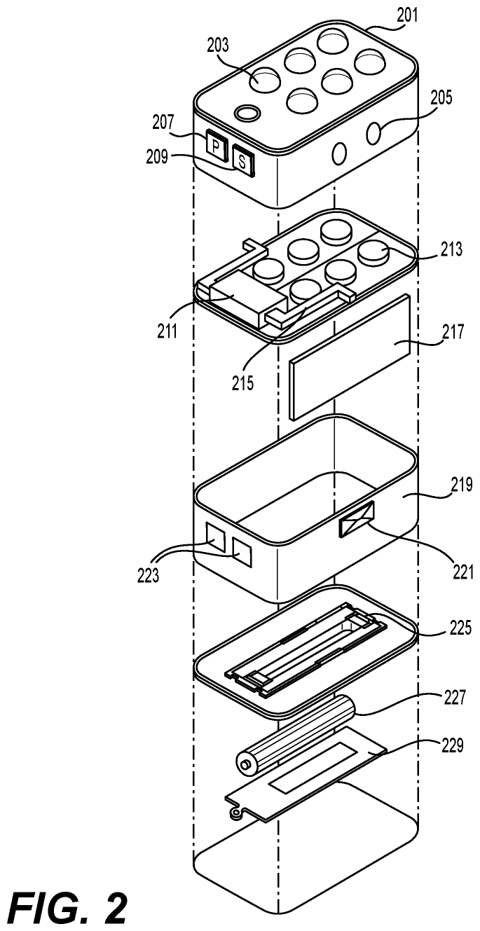

FIG. 2 shows all physical components of a BC within the outer shell 201 in the form of an exploded view. A BC contains six tactile dots 203, arranged in three rows and two columns. A BC can be connected to another BC using a physical connectivity mechanism in the form of a connection point 205 to form a network. A BC can serve as a primary or secondary node with two lights showing its current mode as primary 207 or secondary 209. The BC has a control unit (CU) 211 that includes essential components such as circuitry and firmware for communication, logic, and a mechanism for raising and lowering the tactile dots 213. The physical connectivity mechanism in the form of connection points 205 are internally connected to the CU 211 using a wire 215. BCs are physically connected to each other using a magnet 217 present on both sides of the BC. The internal shell 219 of the BC provides connection points housing 221 for the connection points 205 and a mode lights housing 223 for the mode lights 207, 209. The lower part of the BC includes the essential components for power, including a battery compartment 225, replaceable battery 227, and the closing lid 229.1.

In a particular embodiment, the powered dynamic reusable braille cell includes: an outer shell having six tactile dots arranged in three rows and two columns; a wireless connectivity mechanism; a physical connectivity mechanism; a control unit; a push notifications component; and a speaker, as well as a tactile dots raising and lowering mechanism to raise and lower the tactile dots.

As described above, the physical component of the BC include a control unit. In an embodiment, the control unit is configured to, among other things: wirelessly connect the braille cell with an external controller; communicate with the external controller; determine a role of the braille cell in a network of braille cells; configure the tactile dots to represent a particular character; report a current configuration of the tactile dots to the external controller; reconfigure the tactile dots; monitor a state of charge of a battery located in the braille cell; determine a fault tolerance of the braille cell; push notifications; and control the speaker of the braille cell. As such, the control unit contains the requisite hardware and software to perform these various functions.

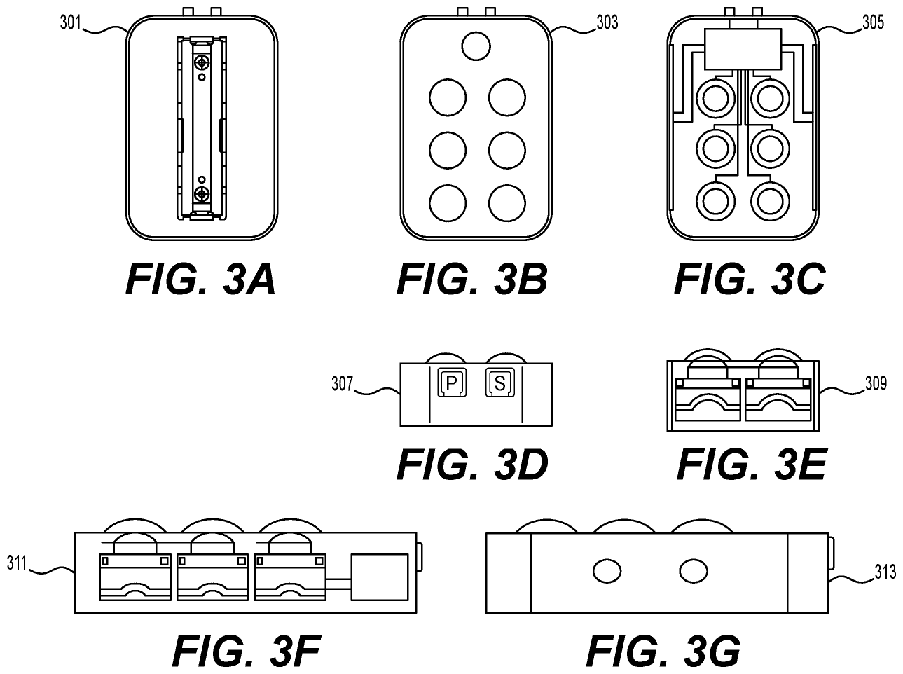

FIGS. 3A to 3G provide various perspectives of a BC, including the bottom view 301 (FIG. 3A), top views (external 303 (FIG. 3B) and internal 305 (FIG. 3C)), front views (external 307 (FIG. 3D) and internal 309 (FIG. 3E)), and side views (internal 311 (FIG. 3F) and external 313 (FIG. 3G)).

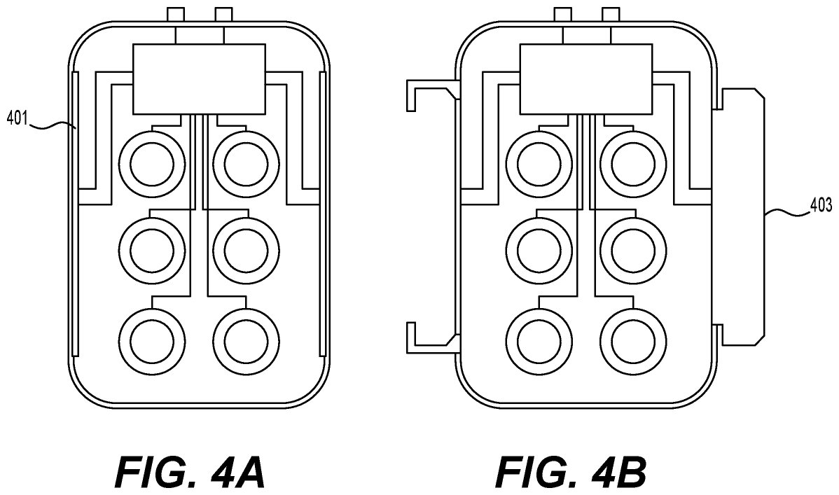

To convey a meaningful message, multiple BCs are interconnected. For this purpose, one embodiment supports various physical connection mechanisms. FIGS. 4A and 4B shows two available implementations for connection on a BC, i.e., a magnetic connection 401 (FIG. 4A) and mechanical interlock 403 (FIG. 4B).

Other embodiments exploit the connection mechanisms described above to create networks that include an arbitrary number of BCs. Within such networks, a BC can assume one of three roles: primary, secondary, or dual node. This role assignment is motivated by the substantial difference in battery power consumption between wireless and wired communication channels. Thus, to prolong the battery life of BCs, a mechanism is employed where only one node communicates with the controller wirelessly. All other nodes use their wired connections for communication. That is, all communications from the external controller or Controller are received by the left-most (head) node wirelessly and are subsequently relayed through wired connections to all other nodes, terminating at the right-most (tail) node. Conversely, communication from the network side to the controller travels from the tail node to the head node via wired connections. Finally, the head node passes the message to the controller wirelessly. Furthermore, as used herein, push notifications are messages shared among the primary and secondary nodes, and the message sent from the head node to the controller.

In some embodiments, the node in the network is configured to operate as: a braille cell network discovery mechanism; a braille cell network connection mechanism; a mechanism to query the current configuration of braille cell network; a braille cell network configuration mechanism; a braille cell network reconfiguration mechanism; a braille cell network reset mechanism; a fault tolerance mechanism by pushing a message; a mechanism to ensure physical integrity by pushing a message.

As used herein throughout, when used with respect to certain “mechanisms”, it is understood that the term encompasses the necessary hardware and software to perform the various functions of the mechanism. When used as a structural “mechanism”, then it is understood that the term encompasses the structural components for the physical mechanism to perform the function.

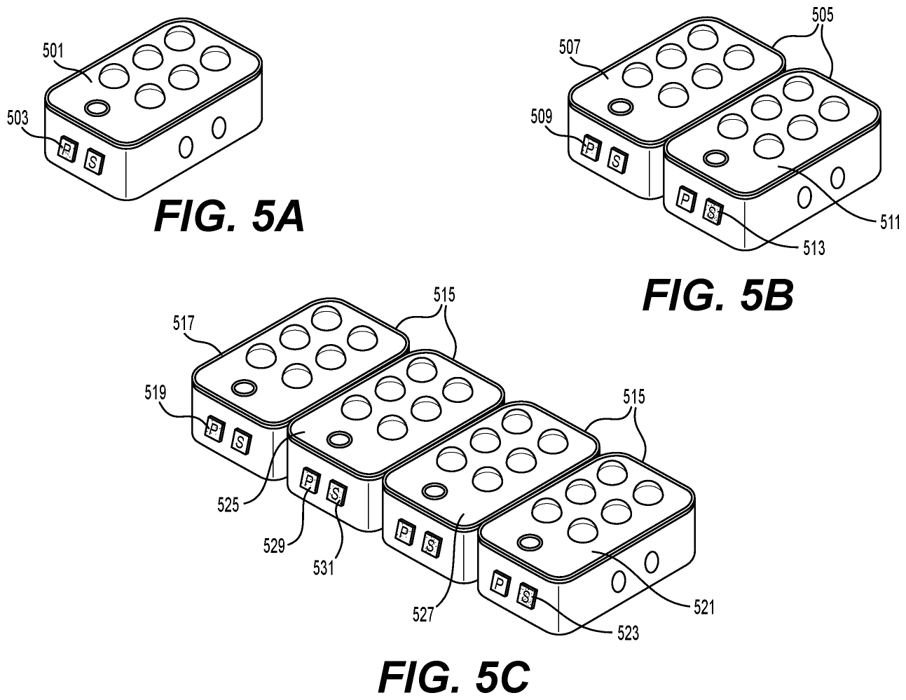

In one of the embodiments shown in FIG. 5A, a single-cell node 501 works as a primary node showing its status using its primary mode light 503. Single-cell node 501 works as a primary node to enable: a braille cell network discovery mechanism; a braille cell network connection mechanism; a mechanism to query the current configuration of braille cell network; a braille cell network configuration mechanism; a braille cell network reconfiguration mechanism; a braille cell network reset mechanism; a fault tolerance mechanism by pushing a message; a mechanism to ensure physical integrity by pushing a message; and a mechanism to ensure data integrity by restricting invalid input.

In the braille cell network discovery mechanism, available head node each broadcast a unique physical address, and the external controller detects and shows a list of such addresses, while the connection mechanism allows the external controller to connect with a braille cell network by selecting one from a list of available head nodes. The braille cell network query mechanism allows the external controller to query the head node of the connected braille cell network for a current configuration, and the braille cell network configuration mechanism allows the external controller to configure input provided by a user on a connected braille cell network. The braille cell network configuration mechanism allows the external controller to replace the current configuration of the connected braille cell network with a new user input. The braille cell network reset mechanism allows the external controller to reset a connected braille cell network by lowering the tactile dots of all braille cells.

The braille cell network fault-tolerance mechanism is configured to: determine a critical battery state of charge of a braille cell node; reset a braille cell network; send push notifications from each braille cell in the network to the external controller; and emit a sound (beep) from each braille cell in the network. Meanwhile, the mechanism to ensure physical integrity of the braille cell network is configured to: detect physical loss or damage to a braille cell node in a braille cell network; reset the braille cell network; send push notifications from each braille cell in the braille cell network to the external controller; and emit a sound (beep) from each braille cell in the braille cell network. Further, the mechanism to ensure data integrity of the braille cell network allows the external controller to validate input provided by a user and prevents the input of any unsupported character.

In another embodiment shown in FIG. 5B, a pair of nodes 505 have the left node 507 working as the primary (indicated by mode light 509) and its right node 511 working as the secondary (indicated by mode light 513).

In another embodiment shown in FIG. 5C, an array having more than two nodes 515 designates its left-most node 517 as the primary node, indicated by mode light 519, while the right-most node 521 serves as the secondary node, indicated by mode light 523. Each intermediate node operates as a secondary node for its immediate left node and a primary node for its immediate right node. For example, referring to FIG. 5C, the intermediate node 525 functions as a secondary node for its left node 517 and a primary node for its right node 527, indicated by mode lights 529 and 531. It is important to note that the last node (tail node) assumes the exclusive role of a secondary node in this case.

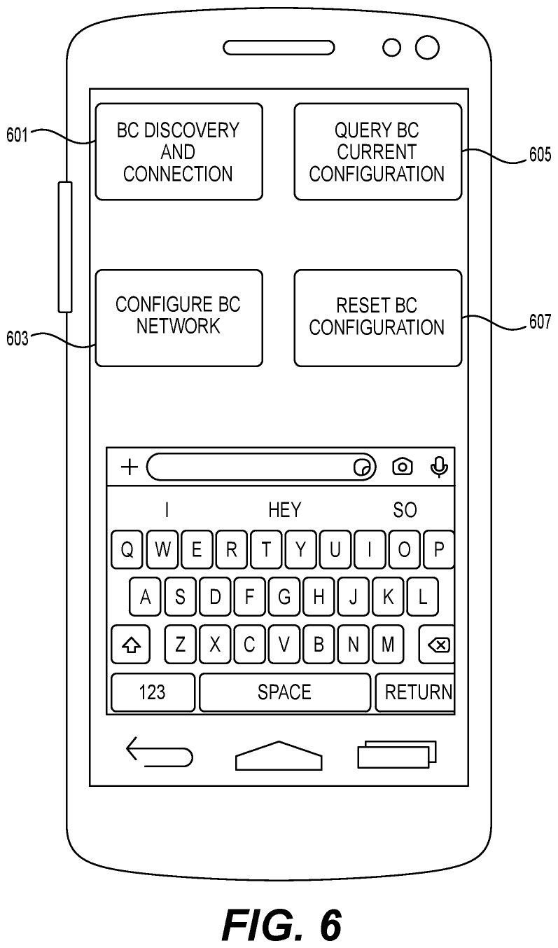

One embodiment relates to the software component hosted on an external controller or Controller device to enable the functionality of the BCs. Referring to FIG. 6, the key functions of the BC Controller include functions related to BC discovery and connection 601, configuring BC network 603, querying BC current configuration 605, and resetting BC configuration 607.

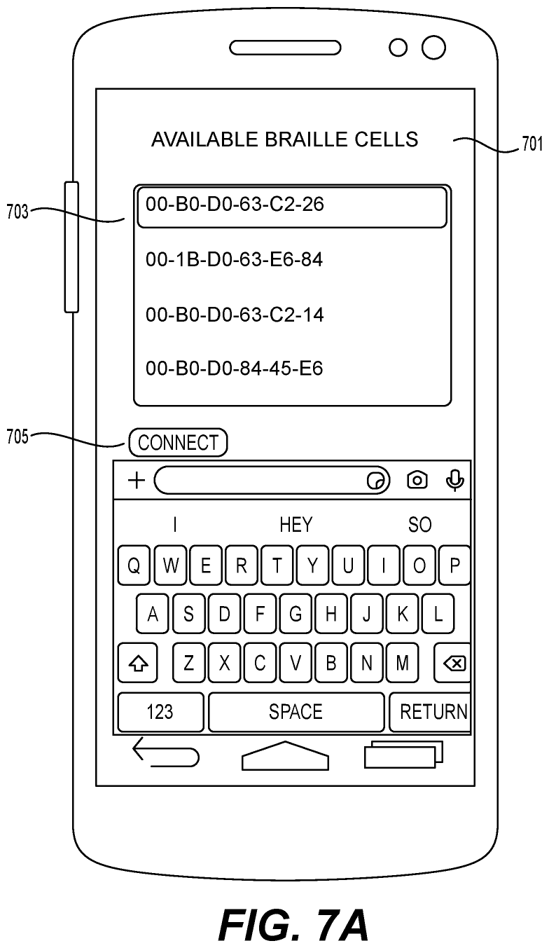

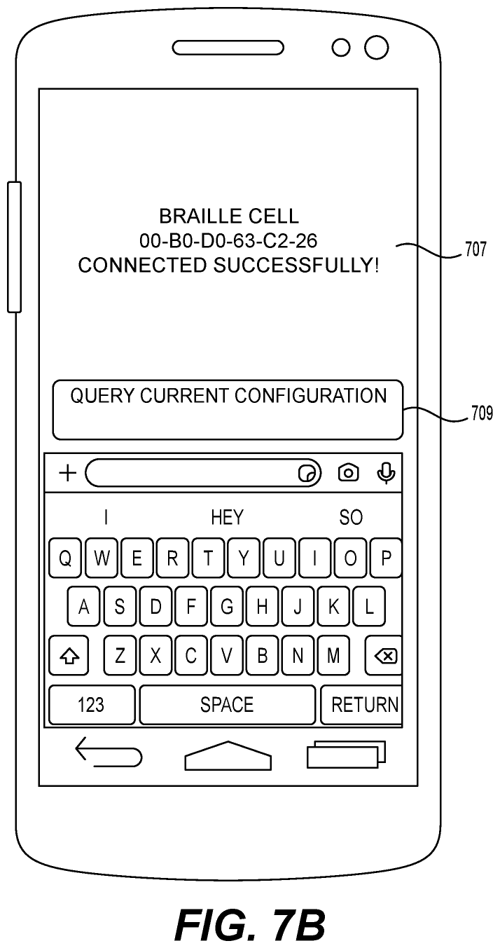

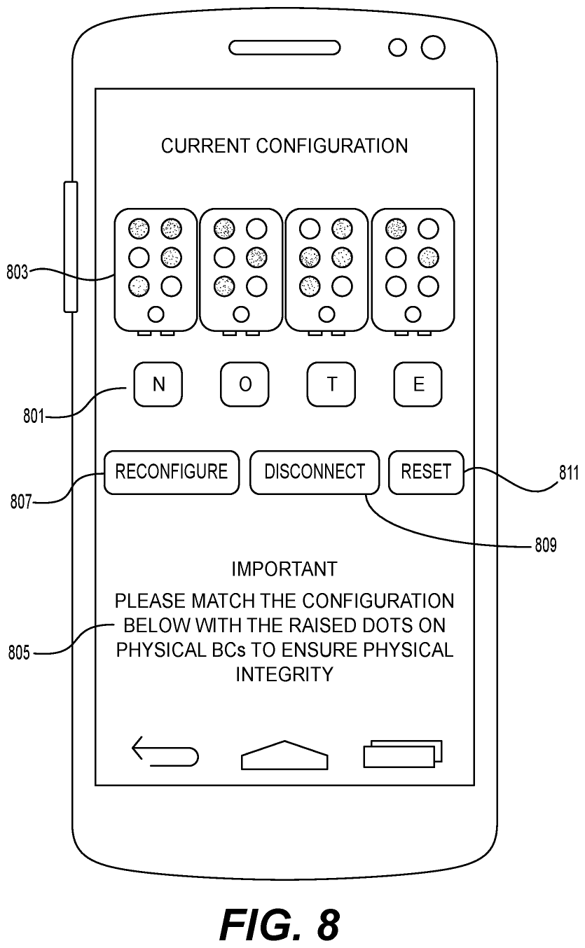

One embodiment allows discovery of and connection to available BC networks. Referring to FIG. 7A, a list of all available BC networks 701 is discovered and presented, shown as a list of physical addresses of all the available head nodes. It is important to note that, as described previously, only one node per network establishes a connection with the controller. The user can select a particular BC (head node of a network) 703 and use the connect button 705 to establish a connection. Referring to FIG. 7B, the user receives a confirmation message 707 upon successful connection to a network. Further, the user can query the current configuration of the connected network 709.

In another embodiment the current configuration of the BC network is displayed in both natural language text and corresponding tactile dots. Referring to FIG. 8, the system shows the current message set on the BC network in the form of natural language text 801, along with the corresponding Braille output represented by tactile dots 803, aligned with the message text. To ensure accuracy, the user is prompted with a clear message 805 to verify the currently displayed configuration on the screen against the physical network setup. Additionally, the user is provided with options to change the current configuration 807, disconnect the BC network 809, and reset the configuration 811.

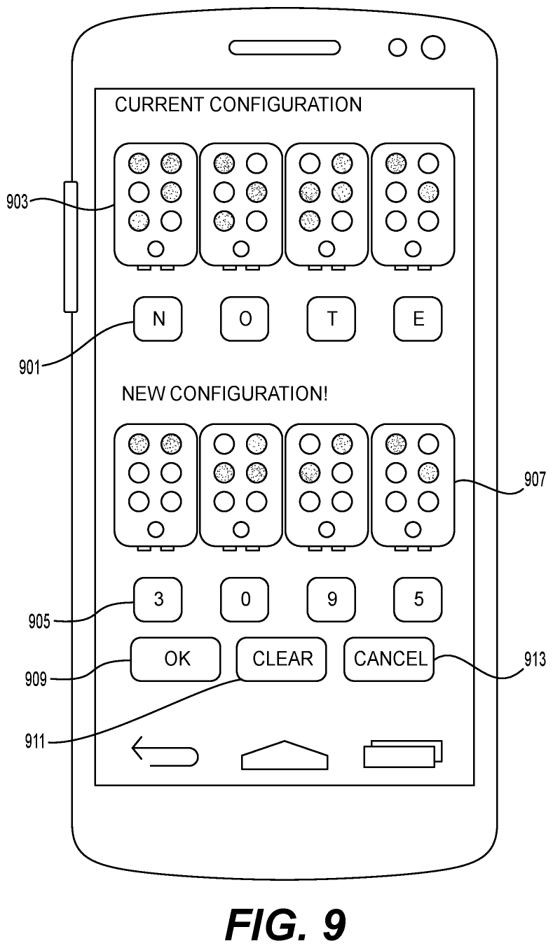

In another embodiment the user to can modify the current configuration of a BC network with a new message. For this purpose, the system shows the current configuration of the BC network in both natural language text and its corresponding Braille representation using tactile dots. Referring to FIG. 9, the system shows the message currently set on the BC network as natural language text 901 alongside the Braille representation depicted through tactile dots 903, aligned with the message. The user can provide a new message using natural language text 905. Subsequently, the system shows the corresponding tactile dot configuration for each BC 907. The user is then provided with options to confirm the new configuration 909, clear the provided input 911, or cancel the operation 913.

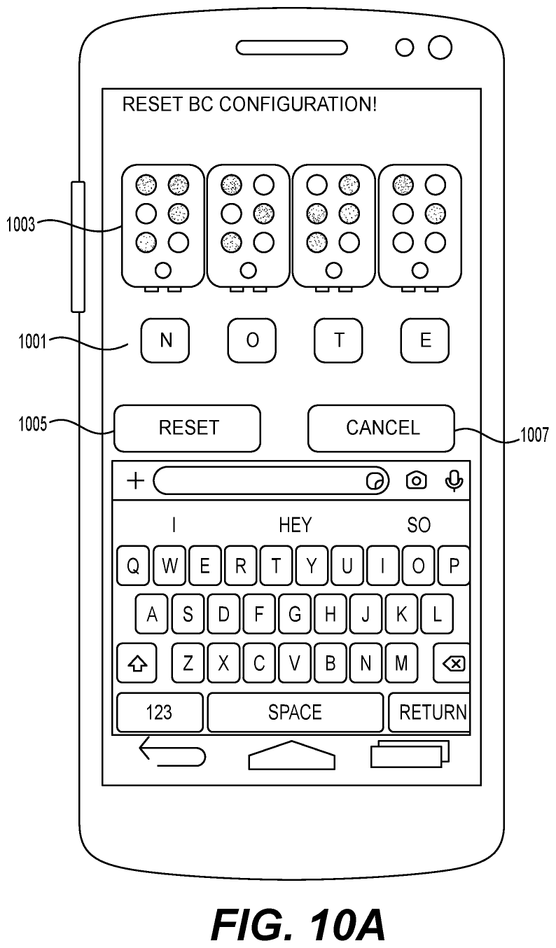

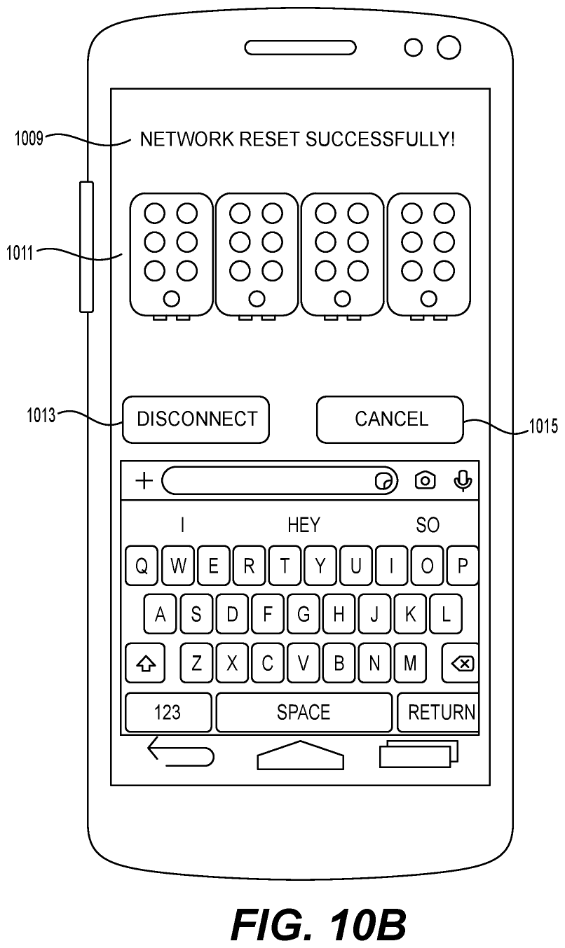

In another embodiment, the user can reset the current configuration of the BC network. Referring to FIGS. 10A and 10B, the system shows the current configuration of the BC network in both natural language text 1001 and its corresponding tactile dots representation 1003. The user may reset 1005 the configuration or cancel 1007 the operation. The system displays a message 1009 on successful completion of the reset operation. The tactile dots on all cells of the BC network are shown on the screen in their initial flat state 1011. Furthermore, the user is provided with options to disconnect 1013 the currently connected BC network, or cancel the operation 1015.

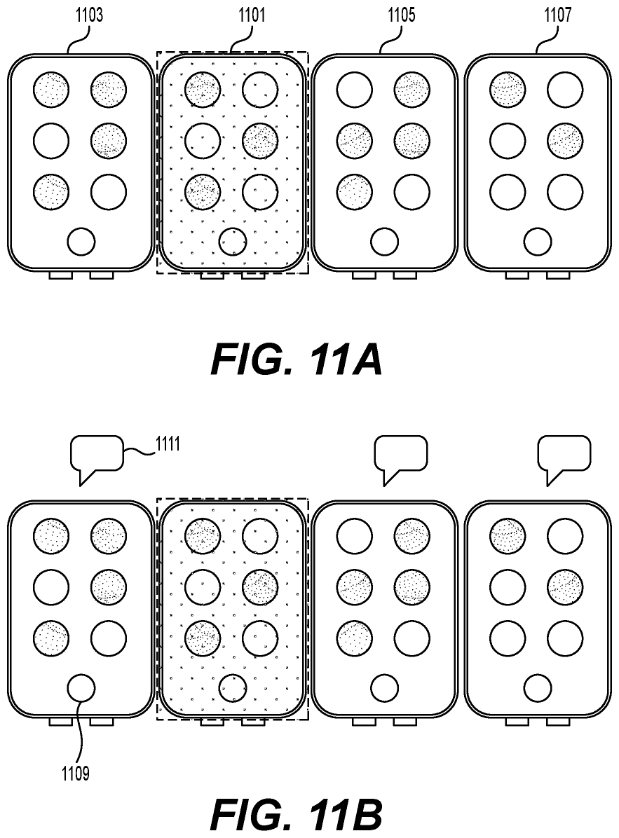

One embodiment utilizes a fault tolerance mechanism of the system. The default tolerance mechanism ensures that if a BC within the network experiences a critical low battery level, it will perform a self-reset and notify both its primary and secondary BCs, as applicable. Referring to FIGS. 11A and 11B, one BC 1101 on the network reaches a critically low battery level. Consequently, the BC 1101 resets itself and relays a message about its low battery status to its primary 1103 and secondary 1105 BCs via the wired connection between them. Each message recipient then passes this message along to its immediate neighboring BC. In this way, BC 1105 transmits the received message to its secondary BC 1107. In addition, all BCs on the network, except the one with the critically low battery, activate their available speakers 1109 to emit a sound (beep) followed by sending a notification 1111 to the controller, signaling a network fault. Finally, all the tactile dots on each cell of the BC network are reset.

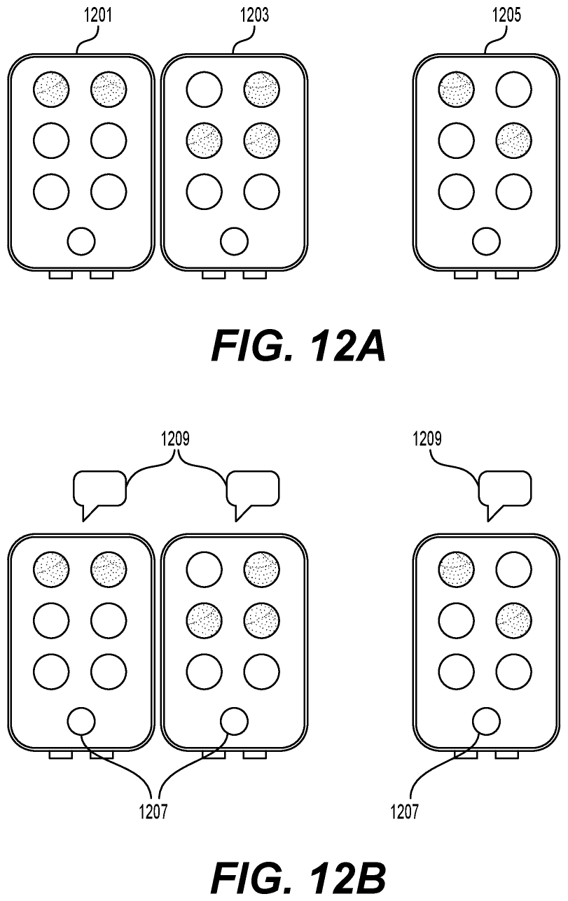

Another embodiment includes a mechanism to ensure the physical integrity of the system. The system has incorporated a physical integrity mechanism where each BC continuously sends pulses to its primary and secondary nodes, as applicable. If a BC fails to confirm the activity of its neighboring BC, it transmits a message to the available neighboring BC on the opposite side, triggering the same process throughout the network. Referring to FIG. 12A, three BCs 1201, 1203, and 1205 are shown, where one BC has become inactive (or lost). Consequently, as shown in FIG. 12B, all BCs within the network will activate their available speakers 1207 to emit a sound (beep) and simultaneously notify the controller 1209 about the network fault. Ultimately, all tactile dots on each cell of the BC network are reset.

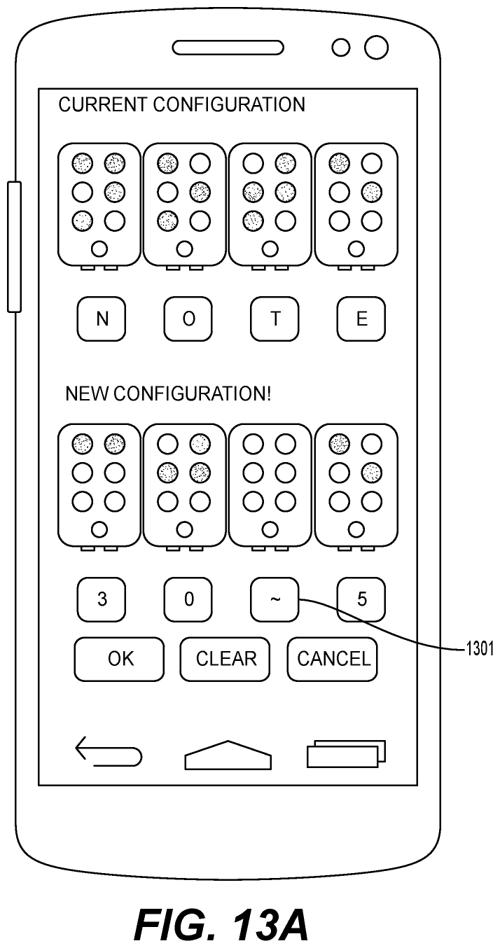

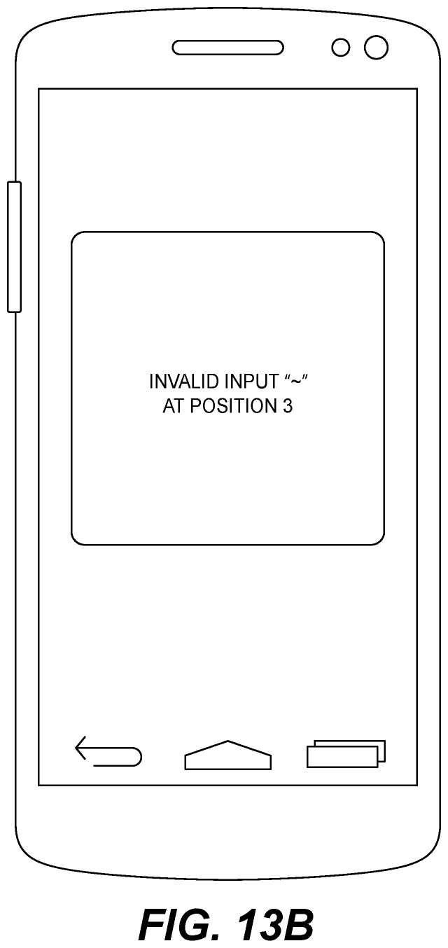

Another embodiment ensures the data integrity of the system by preventing the acceptance of invalid inputs by BCs. To this end, further to the reconfiguration process described above, this embodiment encapsulates the system's behavior when a user attempts to configure an unsupported character on a BC. Referring to FIG. 13A, suppose the user inputs an unsupported character “˜” 1301 to be displayed on the third BC within the network. As a result, as shown in FIG. 13B, the system displays a message 1303 showing the unsupported character along with its position in the BC network.

It is to be understood that the present subject matter is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A powered dynamic reusable braille cell, comprising:
an outer shell having six outer shell tactile dots arranged in three rows and two columns;
a control unit having a wireless connectivity mechanism and a push notifications component, the control unit located within the outer shell;
a physical connectivity mechanism having a connection point located on an outer portion of the outer shell, the physical connectivity mechanism in communication with the control unit;
a tactile dots raising and lowering mechanism having tactile dots corresponding to each of the six outer shell tactile dots, the tactile dots raising and lowering mechanism in communication with the control unit and the outer shell to raise and lower the six outer shell tactile dots with the tactile dots; and
a speaker located within the outer shell and in communication with the control unit.

2. (canceled)

3. The powered dynamic reusable braille cell of claim 1, wherein the control unit is configured to:
wirelessly connect the braille cell with an external controller;
communicate with the external controller;
determine a role of the braille cell in a network of braille cells;
configure the tactile dots to represent a particular character;
report a current configuration of the tactile dots to the external controller;
reconfigure the tactile dots;
monitor a state of charge of a battery located in the braille cell; and
determine a fault tolerance of the braille cell; push notifications; and control the speaker of the braille cell.

4. The powered dynamic reusable braille cell of claim 1, wherein the physical connectivity mechanism includes a magnet.

5. The powered dynamic reusable braille cell of claim 1, wherein the physical connectivity mechanism includes a mechanical interlock.

6. A network of powered dynamic reusable braille cells comprising a plurality of powered dynamic reusable braille cells of claim 3, wherein the plurality of powered dynamic reusable braille cells are interconnected by the respective physical connectivity mechanisms.

7. The network of powered dynamic reusable braille cells of claim 6, wherein one of the plurality of powered dynamic reusable braille cells is designated as a node within the network, the node being configured to operate as:
a braille cell network discovery mechanism;
a braille cell network connection mechanism;
a mechanism to query the current configuration of braille cell network;
a braille cell network configuration mechanism;
a braille cell network reconfiguration mechanism;
a braille cell network reset mechanism;
a fault tolerance mechanism by pushing a message;
a mechanism to ensure physical integrity by pushing a message.

8. The network of powered dynamic reusable braille cells of claim 6, wherein one of the plurality of powered dynamic reusable braille cells is designated as a primary node, where the primary node enables wireless communication between the controller and any secondary nodes in the braille cell network; and communication between the primary node and any secondary nodes is carried out using a wired medium.

9. The network of powered dynamic reusable braille cells of claim 6, wherein at least one of the plurality of powered dynamic reusable braille cells is designated as a dual node in the braille cell network, wherein the dual node includes the functions of a primary node and a secondary node.

10. The network of powered dynamic reusable braille cells of claim 6, wherein one of the plurality of powered dynamic reusable braille cells is designated as a head node in the braille cell network, wherein the head node is a left-most node in the braille cell network; and the head node is configured to: support the discovery of braille cell network by the external controller; enable the connection of braille cell network with the external controller; and enable wireless communication with the external controller.

11. The network of powered dynamic reusable braille cells of claim 6, wherein one of the plurality of powered dynamic reusable braille cells is designated as a tail node in the braille cell network, wherein the tail node is a right-most node in the braille cell network and serves as a terminal point in the braille cell network.

12. The powered dynamic reusable braille cell of claim 3, wherein the external controller is configured to establish communication with a primary node to enable:
a braille cell network discovery mechanism;
a braille cell network connection mechanism;
a mechanism to query the current configuration of braille cell network;
a braille cell network configuration mechanism;
a braille cell network reconfiguration mechanism;
a braille cell network reset mechanism;
a fault tolerance mechanism by pushing a message;
a mechanism to ensure physical integrity by pushing a message; and
a mechanism to ensure data integrity by restricting invalid input.

13. The powered dynamic reusable braille cell of claim 12 wherein, in the braille cell network discovery mechanism, available head nodes each broadcast a unique physical address, and the external controller detects and shows a list of such addresses.

14. The powered dynamic reusable braille cell of claim 12 wherein the connection mechanism allows the external controller to connect with a braille cell network by selecting one from a list of available head nodes.

15. The powered dynamic reusable braille cell of claim 14 wherein the braille cell network query mechanism allows the external controller to query the head node of the connected braille cell network for a current configuration.

16. The powered dynamic reusable braille cell of claim 12 wherein the braille cell network configuration mechanism allows the external controller to configure input provided by a user on a connected braille cell network.

17. The powered dynamic reusable braille cell of claim 16 wherein the braille cell network configuration mechanism allows the external controller to replace the current configuration of the connected braille cell network with a new user input.

18. The powered dynamic reusable braille cell of claim 12 wherein the braille cell network reset mechanism allows the external controller to reset a connected braille cell network by lowering the tactile dots of all braille cells.

19. The powered dynamic reusable braille cell of claim 12 wherein the braille cell network fault-tolerance mechanism is configured to: determine a critical battery state of charge of a braille cell node; reset a braille cell network; send push notifications from each braille cell in the network to the external controller; and emit a sound from each braille cell in the network.

20. The powered dynamic reusable braille cell of claim 12 wherein the mechanism to ensure physical integrity of the braille cell network is configured to:
detect physical loss or damage to a braille cell node in a braille cell network;
reset the braille cell network;
send push notifications from each braille cell in the braille cell network to the external controller; and
emit a sound from each braille cell in the braille cell network.
